(19) United States
(12) Patent Application Publication
(10) Pub. No.: US 2025/0357811 A1
(43) Pub. Date: Nov. 20, 2025

(54) ELECTRIC GENERATOR, COIL ELEMENT, MOTOR, AND AIRCRAFT

(71) Applicant: JAPAN AEROSPACE EXPLORATION AGENCY, Tokyo (JP)

(72) Inventors: Hiroshi KOBAYASHI, Tokyo (JP); Ryuji IIJIMA, Tokyo (JP); Akira NISHIZAWA, Tokyo (JP); Shunsuke NOGUCHI, Tokyo (JP)

(21) Appl. No.: 18/291,945

(22) PCT Filed: Jul. 20, 2022
(86) PCT No.: PCT/JP2022/028233

§ 371 Date: Feb. 18, 2025

(30) Foreign Application Priority Data
Jul. 30, 2021 (JP) 2021-125032

(51) Int. Cl. H02K 3/18; H02K 3/28; H02K 7/18; H02K 11/26

(52) U.S. Cl. CPC H02K 3/18; H02K 3/28; H02K 7/1807; H02K 11/26

(57) ABSTRACT

An electric generator according to the present technology includes a coil element. The coil element includes a magnetic core and two or more windings. The magnetic core causes a magnetic flux change in an axial direction. The two or more windings that are each helically wound around the magnetic core in such a manner that each of the two or more windings is adjacent to the other winding in the axial direction of the magnetic core and are independent windings each capable of being electrically separated from the other winding.

### TECHNICAL FIELD

The present technology relates to a technology for an electric generator or the like mounted on an aircraft, for example.

### BACKGROUND ART

An aircraft engine provides thrust necessary for an aircraft's flight for example by generating a jet flow by rotation of an engine shaft. An electric generator for generating electric power consumed inside the aircraft is coupled to the engine shaft in some cases.

The electric generator is constituted by a rotor (permanent magnet) coupled to the engine shaft and a stator including teeth, three-phase coils wound around the teeth, and the like. Rotation of the engine shaft rotates the rotor so that three-phase alternating current is generated in the three-phase coils.

For example, Patent Literature 1 has disclosed a technology related to this application.

### CITATION LIST

### Patent Literature

Patent Literature 1: Japanese Patent Application Laid-open No. 2019-79868

### DISCLOSURE OF INVENTION

### Technical Problem

This type of electric generator may have a fault such as a short-circuit in the electric generator coil. An electric generator with a typical coil cannot stop the fault by electrical operation and needs to stop the engine. However, in a case where the electric generator is used for an aircraft, it is difficult to stop the rotation of the engine shaft even in such a situation (because the aircraft will crash if so). Thus, the engine shaft keeps rotating and the electric generator rotor keeps rotating even in a case where a fault such as a coil short-circuit has occurred.

In such a case, counter electromotive force due to the rotation of the engine shaft keeps generating high heat due to short-circuit current in the electric generator coil. It may lead to fire in the engine.

In view of the above-mentioned circumstances, it is an objective of the present technology to provide a technology for an electric generator or the like capable of minimizing damage due to a short-circuit in a coil.

### Solution to Problem

In order to accomplish the above-mentioned objective, an electric generator according to the present technology includes a coil element.

The coil element includes a magnetic core and two or more windings.

The magnetic core causes a magnetic flux change in an axial direction.

The two or more windings that are each helically wound around the magnetic core in such a manner that each of the two or more windings is adjacent to the other winding in the axial direction of the magnetic core and are independent windings each capable of being electrically separated from the other winding.

In this electric generator, the two or more windings are wound around the magnetic core in such a manner that portions of the same winding are not adjacent to each other and are independent windings electrically separated from each other. Therefore, since in this electric generator, even if a short-circuit has occurred, the short-circuit is a short-circuit between the different independent windings electrically separated from each other, a loop path is not easily formed in the coil and short-circuit current does not easily flow there. Thus, even if a short-circuit has occurred in the coil, its damage can be minimized.

In the electric generator, the two or more windings may be laminated in multiple layers in a radial direction orthogonal to the axial direction of the magnetic cores and may be each adjacent to the other winding in the radial direction.

In the electric generator, the coil element may include two or more switch mechanisms that are provided to two or more windings and are capable of switching between a connected state and a disconnected state with/from an external circuit.

In the electric generator, the coil element may include a plurality of coil elements corresponding to a plurality of phases, and the switch mechanisms may be capable of switching between the connected state and the disconnected state of each portion of the two or more windings, each portion corresponding to each phase.

In the electric generator, in a case where a sign of a short-circuit or a short-circuit between windings is detected, the switch mechanism may switch the connected state of at least one winding to the disconnected state.

In the electric generator, in a case where a sign of a short-circuit or a short-circuit between windings is detected, current to cancel a magnetic flux change caused in the magnetic core may be supplied to at least one winding.

The electric generator may further include a detector that detects a sign of a short-circuit or a short-circuit between windings.

In the electric generator, the two or more windings may have a potential difference between windings adjacent to each other, and
the detector may detect the sign of the short-circuit or the short-circuit by detecting the potential difference or an electrical element caused by the potential difference.

In the electric generator, the two or more windings may have a potential difference between windings adjacent to each other because of different winding patterns.

In the electric generator, the two or more windings may be different from each other in the number of windings.

In the electric generator, the magnetic core may include a first magnetic core and a second magnetic core,
the first magnetic core may include a first bottom end portion and a first top end portion on both end sides in the axial direction,
the second magnetic core may include a second bottom end portion and a second top end portion on both end sides in the axial direction,
a first winding of the two or more windings may be wound around the first magnetic core toward a side of the first top end portion from a side of the first bottom end portion and then wound around the second magnetic core toward a side of the second bottom end portion from a side of the second top end portion, and
a second winding of the two or more windings may be wound around the second magnetic core toward the side of the second bottom end portion from the second top end portion and then wound around the first magnetic core toward the side of the second top end portion from the side of the first bottom end portion.

In the electric generator, the electrical element may include at least any one of partial discharge current, capacitance, or insulation resistance between windings adjacent to each other.

In the electric generator, voltage to detect the electrical element may be applied between windings at a predetermined cycle.

In the electric generator, the detector may detect a sign of a short-circuit or a short-circuit during electricity generation by the electric generator.

In the electric generator, the detector may detect a sign of a short-circuit or a short-circuit during non-electricity generation by the electric generator.

A coil element according to the present technology includes a magnetic core and two or more windings.

The magnetic core causes a magnetic flux change in an axial direction.

The two or more windings are each helically wound around the magnetic core in such a manner that each of the two or more windings is adjacent to the other winding in the axial direction of the magnetic core and are independent windings each capable of being electrically separated from the other winding.

A motor according to the present technology includes a coil element.

The coil element includes a magnetic core and two or more windings.

The magnetic core causes a magnetic flux change in an axial direction.

The two or more windings are each helically wound around the magnetic core in such a manner that each of the two or more windings is adjacent to the other winding in the axial direction of the magnetic core and are independent windings each capable of being electrically separated from the other winding.

An aircraft according to the present technology includes an electric generator.

The electric generator includes a coil element.

The coil element includes a magnetic core and two or more windings.

The magnetic core causes a magnetic flux change in an axial direction.

The two or more windings are each helically wound around the magnetic core in such a manner that each of the two or more windings is adjacent to the other winding in the axial direction of the magnetic core and are independent windings each capable of being electrically separated from the other winding.

An aircraft according to the present technology includes a motor.

The motor includes a coil element.

The coil element includes a magnetic core and two or more windings.

The magnetic core causes a magnetic flux change in an axial direction.

The two or more windings are each helically wound around the magnetic core in such a manner that each of the two or more windings is adjacent to the other winding in the axial direction of the magnetic core and are independent windings each capable of being electrically separated from the other winding.

### Advantageous Effects of Invention

As described above, in accordance with the present technology, a technology for an electric generator or the like capable of minimizing damage due to a short-circuit in a coil can be provided.

### BRIEF DESCRIPTION OF DRAWINGS

FIG. 1 A diagram showing an example of an aircraft engine mounted on an aircraft.

FIG. 2 A diagram showing a configuration of an electric generator according to a first embodiment.

FIG. 3 A diagram showing an example of switches in a case of partially cutting off a portion related to a phase where a short-circuit has occurred.

FIG. 4 A diagram showing an example of a coil constituted by a first winding and a second winding.

FIG. 5 A diagram showing another example in the coil.

FIG. 6 A diagram showing a still another example in the coil.

FIG. 7 A diagram showing an electric generator according to a second embodiment.

FIG. 8 A diagram for comparing magnetic flux and short-circuit current in an electric generator according to a comparative example and the electric generator according to the second embodiment.

FIG. 9 A diagram for comparing coil temperature in the electric generator according to the comparative example and the electric generator according to the second embodiment.

FIG. 10 A diagram showing a first example regarding detection of a sign of a short-circuit or a short-circuit in two or more windings.

FIG. 11 A diagram showing a potential difference ΔV between the first winding and the second winding.

FIG. 12 A diagram showing an example of partial discharge current.

FIG. 13 A diagram showing a change in potential difference ΔV before/after the short-circuit.

FIG. 14 A diagram showing an example in a case where a plurality of voltmeters is provided in single-phase coils.

FIG. 15 A diagram showing an example in a case where a plurality of voltmeters is provided in three-phase coils.

FIG. 16 A diagram showing an example in a case where a plurality of voltmeters is provided in three-phase coils.

FIG. 17 A diagram showing partial discharge current when exploration voltage is applied.

FIG. 18 A diagram showing a second example regarding detection of a sign of a short-circuit or a short-circuit in two or more windings.

FIG. 19 A diagram showing a potential difference ΔV between the first winding and the second winding.

### MODE(S) FOR CARRYING OUT THE INVENTION

Hereinafter, embodiments of the present invention will be described with reference to the drawings.

### First Embodiment

### <Overall Configuration of Electric Generator 14 and Configurations of Respective Portions>

### [Configuration of Aircraft Engine 10]

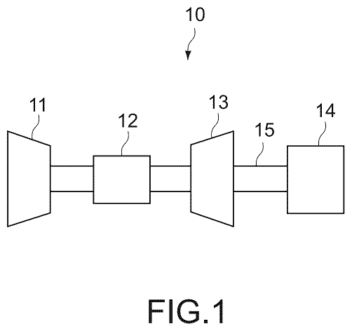

FIG. 1 is a diagram showing an example of an aircraft engine 10 mounted on an aircraft. As shown in FIG. 1, the aircraft engine 10 is, for example, a jet engine (turbojet, turbofan, turboprop, turboshaft) and includes a compressor 11, a combustor 12, a turbine 13, an electric generator 14, and an engine shaft 15. The engine shaft 15 is coupled to the compressor 11, the combustor 12, the turbine 13, and the electric generator 14.

The compressor 11 suctions and compresses the front air by rotation and feeds generated air streams to the combustor 12 behind it. The combustor 12 burns fuel in a combustion room and expands the compressed air and feeds the high-temperature air streams to the turbine 13 behind it. The turbine 13 is rotated by the air streams from the combustor 12 and discharges the air streams rearwards at the same time.

Rotation of the turbine 13 rotates the engine shaft 15. The rotational force of the engine shaft 15 is used as power for rotating the compressor 11. The rotational force of the engine shaft 15 is also used as power for electricity generation by the electric generator 14.

It should be noted that in the description of each embodiment, the electric generator 14 that converts dynamic energy into electric energy will be described as a main example of an apparatus on which a coil element according to the present technology is mounted. However, the apparatus on which the coil element is mounted may be a motor that converts electric energy into dynamic energy or may be an apparatus other than the electric generator 14 and the motor.

Moreover, although the electric generator 14 will be described as an electric generator 14 for aircraft in the description of each embodiment, the electric generator 14 may be a typical electric generator 14 used on the ground. The same applies to the motor and other apparatuses.

### [Configuration of Electric Generator 14]

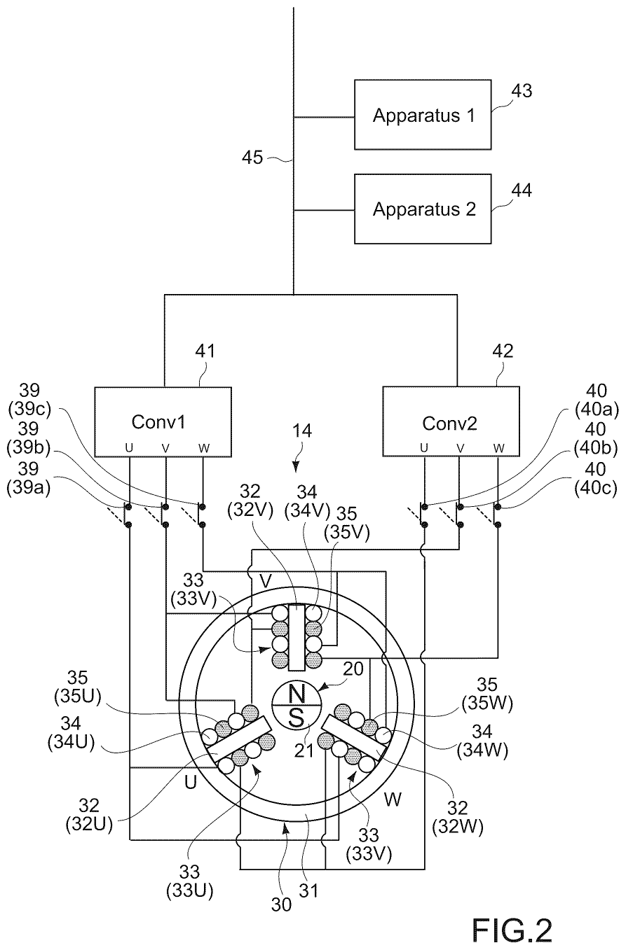

FIG. 2 is a diagram showing a configuration of the electric generator 14. In the present embodiment, a three-phase AC electric generator will be described as an example of the electric generator 14. It should be noted that the electric generator 14 may be a single-phase AC electric generator or the like.

As shown in FIG. 2, the electric generator 14 includes a rotor 20 and a stator 30. The rotor 20 includes a permanent magnet 21. The rotor 20 is coupled to the engine shaft 15 and rotates in accordance with the rotation of the engine shaft 15.

The stator 30 includes an annular back-york portion 31, a plurality of teeth 32 (magnetic cores) protruding radially inwards from the back-york portion 31, and coils 33 respectively provided to the teeth 32. It should be noted that the coil element is constituted by the teeth 32 (magnetic cores), the coils 33 (two or more windings), and the like (it may include a switch to be described later and the like).

The teeth 32 (magnetic cores) cause a magnetic flux change due to the rotation of the permanent magnet 21 in the rotor 20 in their axial directions (length directions). The coils 33 generate electric power with induced electromotive force due to the magnetic flux change caused by the teeth 32.

The teeth 32 are three teeth 32 including a U-phase tooth 32U, a V-phase tooth 32V, and a W-phase tooth 32W. Similarly, the coils 33 are three coils 33 including a U-phase coil 33U, a V-phase coil 33V, and a W-phase coil 33W. It should be noted that although the number of teeth 32 and the number of coils 33 are each set to be three in the example shown in FIG. 2, the number of teeth 32 and the number of coils 33 are not particularly limited.

It should be noted that in this specification, three members having basically similar configurations in three phases, U-, V-, and W-phases, will be referred to as the U-phase . . . , the V-phase . . . , and the W-phase . . . (e.g., the U-phase coil 33U, the V-phase coil 33V, and the W-phase coil 33W) when the three members are especially distinguished. Otherwise, the members will be simply referred to as the member's name (e.g., coils 33) when the three members are not especially distinguished.

The U-phase coil 33U, the V-phase coil 33V, and the W-phase coil 33W have basically similar configurations. The coils 33 are each constituted by a first winding 34 and a second winding 35.

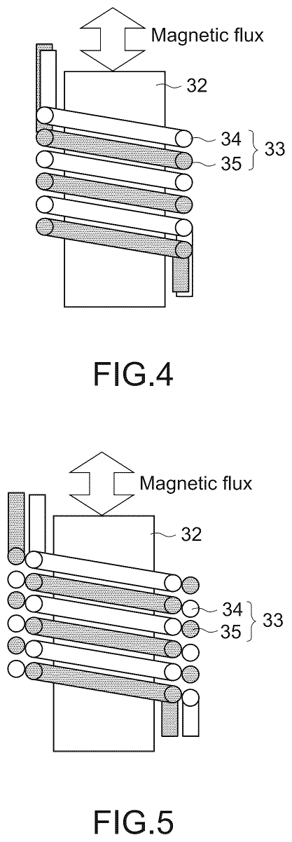

FIG. 4 is a diagram showing an example of the coil 33 constituted by the first winding 34 and the second winding 35.

As shown in FIG. 4, the first winding 34 and the second winding 35 are alternately wound in a helical form around the magnetic core in such a manner that one winding is adjacent to the other winding in the axial direction of the tooth 32 (magnetic core). Moreover, the first winding 34 and the second winding 35 are electrically separated from each other so that they are electrically independent windings (i.e., they are not electrically and physically connected).

It should be noted that in order to increase the insulation between the first winding 34 and the second winding 35, a filler made of insulating material such as resin may be applied so as to cover the first winding 34 and the second winding 35.

Referring back to FIG. 2, a U-phase first winding 34U, a V-phase first winding 34V, and a W-phase first winding 34W are electrically connected to one another. Similarly, a U-phase second winding 35U, a V-phase second winding 35V, and a W-phase second winding 35W are electrically connected to one another.

The connection method of the first windings is a delta connection, and the first windings 34 are respectively connected to a first converter 41 via three first switches 39a, 39b, and 39c (the wiring connection method can be changed as appropriate). Also, the connection method of the second windings 35 is a delta connection, and the second windings 35 are respectively connected to a second converter 42 via three second switches 40a, 40b, and 40c (the wiring connection method can be changed as appropriate).

A bottom end portion side (back york 30 side) of the U-phase first winding 34U and a top end portion side (rotor 20 side) of the W-phase first winding 34W are connected to a U-phase input terminal of the first converter 41 via the switch 39a. Moreover, a bottom end portion side of the V-phase first winding 34V and a top end portion side of the U-phase first winding 34U are connected to a V-phase input terminal of the first converter 41 via the switch 39b. Moreover, a bottom end portion side of the W-phase first winding 34W and a top end portion side of the V-phase first winding 34V are connected to a W-phase input terminal of the first converter 41 via the switch 39c.

A bottom end portion side (back york 30 side) of the U-phase second winding 35U and a top end portion side (rotor 20 side) of the W-phase second winding 35W are connected to a U-phase input terminal of the second converter 42 via the switch 40a. Moreover, a bottom end portion side of the V-phase second winding 35V and a top end portion side of the U-phase second winding 35U are connected to a V-phase input terminal of the second converter 42 via the switch 40b. Moreover, a bottom end portion side of the W-phase second winding 35W and a top end portion side of the V-phase second winding 35V are connected to a W-phase input terminal of the second converter 42 via the switch 40c.

Three first switches 39 (switch mechanisms) are each capable of switching between a connected state and a disconnected state between the first winding 34 (coil 33) and an external apparatus (first apparatus 43 or second apparatus 44). Moreover, three second switches 40 (switch mechanisms) are each capable of switching between a connected state and a disconnected state between the second winding 35 (coil 33) and the external apparatus.

Typically, the first switches 39 or the second switches 40 switches the connected state between the first windings 34 or the second windings 35 and the external apparatus to the disconnected state depending on needs in a case where a sign of a short-circuit or a short-circuit has occurred in the coil 33.

It should be noted that detection of a sign of a short-circuit or a short-circuit in the coil 33 will be described later in detail (see a third embodiment). Moreover, the switching operations of the first switches 39 and the second switches 40 will also be described later in detail.

The first converter 41 and the second converter 42 each include three input terminals and a single output terminal. The three input terminals include a U-phase input terminal, a V-phase input terminal, and a W-phase input terminal. The first converter 41 converts three-phase alternating current generated in the first winding 34 into direct current and provides the direct current to the first apparatus 43 and the second apparatus 44. The second converter 42 converts three-phase alternating current generated in the second winding 35 into direct current and provides the direct current to the first apparatus 43 and the second apparatus 44.

The first apparatus 43 and the second apparatus 44 are connected to the first converter 41 and the second converter 42 via a DC bus 45. The first apparatus 43 and the second apparatus 44 are a variety of apparatuses mounted inside the aircraft. The first apparatus 43 and the second apparatus 44 are driven with electric power generated by the electric generator 14.

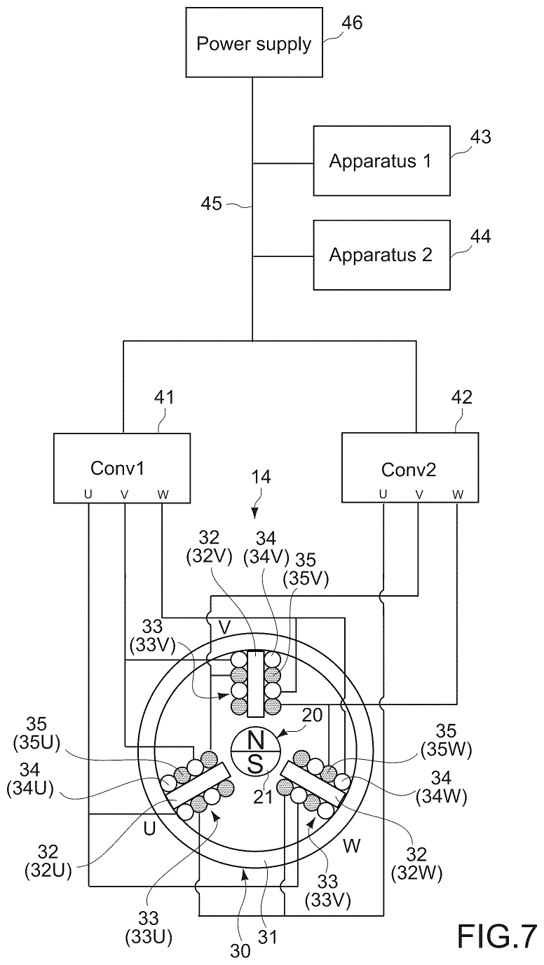

It should be noted that in a case where the present technology is used as an aircraft motor, for example, a power supply 46 is provided on the side of the first apparatus 43 and the second apparatus 44 and inverters that convert direct current from the power supply 46 (e.g., see FIG. 7 to be described later) into alternating current are provided in place of the converters 41 and 42. Moreover, for example, a thruster (target that should be rotated) that produces aircraft thrust is coupled to the shaft of the rotor 20.

### <Short-Circuit in Coil 33>

Next, a short-circuit in the coil 33 will be described. First of all, for example, a case where the coil 33 is constituted by a single winding or a case where the coil 33 is constituted by two windings while the two windings are electrically connected (see Patent Literature 1 above) will be described as a comparative example.

In this comparative example, substantially the same windings are short-circuited, with the result that a loop path due to the short-circuit is formed and short-circuit current flows there. In such a case, the aircraft will crash if the rotation of the engine shaft 15 is stopped in order to stop the driving of the electric generator 14. Therefore, the rotation of the engine shaft 15 cannot be stopped. Therefore, the rotor 20 keeps rotating, and the coil 33 ignites because of a magnetic flux change due to the rotation of the rotor 20. It may lead to fire.

On the other hand, in the present embodiment, the first winding 34 and the second winding 35 are each helically wound around the tooth 32 in such a manner that one winding is adjacent to the other winding.

Therefore, in the present embodiment, portions of the first winding 34 are not adjacent to each other and portions of the second winding 35 are not adjacent to each other. Therefore, if a short-circuit occurs, there will be a short-circuit between the first winding 34 and the second winding 35, not between portions of the first winding 34 or between portions of the second winding 35.

In addition, in the present embodiment, the first winding 34 and the second winding 35 are independent windings electrically separated from each other. Therefore, even if a short-circuit occurs between the first winding 34 and the second winding 35, a loop path due to the short-circuit is not easily formed and short-circuit current does not easily flow there. Therefore, damage due to a short-circuit can be minimized for example even in a situation where the engine shaft 15 should be kept driving in order to keep the rotor 20 rotating.

### <Switching of First Switch 39 and Second Switch 40>

Next, switching between the connected state and the disconnected state at the first switches 39 and the second switches 40 will be described.

In the present embodiment, since the first winding 34 and the second winding 35 are each helically wound around the tooth 32 in such a manner that they are adjacent to each other and the first winding 34 and the second winding 35 are independent windings electrically separated from each other as described above, damage due to a short-circuit in the coil 33 can be minimized. In addition, in the present embodiment, damage due to a short-circuit in the coil 33 is further reduced by the first switches 39 and the second switches 40 cutting off the connection between the coil 33 (first winding 34 and second winding 35) and the external apparatus (first apparatus 43 or second apparatus 44) in a case where a sign of a short-circuit or a short-circuit has occurred in the coil 33.

### [1. Cut Off at Least One of First Winding or Second Winding]

### [A. Cut Off all Three Phases of Either First Windings 34 or Second Windings 35]

It is assumed that a short-circuit occurs between the U-phase first winding 34U and the U-phase second winding 35U in the U-phase coil 33U. In this case, three switches, which are either the three first switches 39 or the three second switches 40, are switched from the connected state to the disconnected state. In this case, the other three switches remain in the connected state.

In this case, either the first windings 34 in the three phases or the second windings in the three phases are cut off from the external apparatus. Moreover, in this case, either the first converter 41 or the second converter 42 converts three-phase alternating current into direct current. Meanwhile, the other converter does not function.

[B. Cut Off all Irrespective of Phase where Short-Circuit has Occurred]

It is assumed that a short-circuit occurs between the U-phase first winding 34U and the U-phase second winding 35U in the U-phase coil 33U. In this case, all the three first switches 39 and the three second switches 40 are switched from the connected state to the disconnected state.

In this case, all the first windings 34 in the three phases and the second windings in the three phases 35 are cut off from the external apparatus. Moreover, in this case, the first converter 41 and the second converter 42 do not function. In this case, the external apparatuses (first apparatus 43 and second apparatus 44) are driven with electric power from another electric generator 14 (e.g., driven by rotation of another engine shaft 15) or electric power from a battery for emergency.

### [2. Cut Off Portion Related to Phase Where Short-Circuit Has Occurred]

Here, out of the first winding 34 and the second winding 35, a portion related to a phase where a short-circuit has occurred may be cut off and a portion not related to the phase where the short-circuit has occurred may be kept in the connected state for generating electric power.

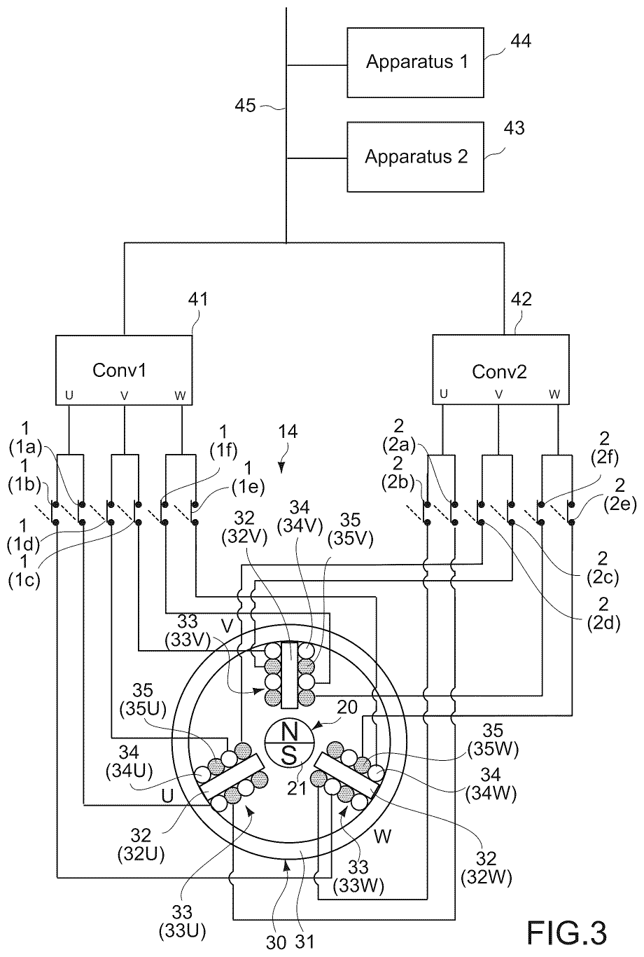

FIG. 3 is a diagram showing an example of switches in a case of partially cutting off the portion related to the phase where the short-circuit has occurred. In the example shown in FIG. 3, the number of first switches 1 and the number of second switches 2 are each set to be six unlike the example shown in FIG. 2.

As shown in FIG. 3, the bottom end portion side (back york 30 side) of the U-phase first winding 34U is connected to the U-phase input terminal of the first converter 41 via a switch 1a and the top end portion side (rotor 20 side) of the W-phase first winding 34W is connected to the U-phase input terminal of the first converter 41 via a switch 1b.

Moreover, the bottom end portion side of the V-phase first winding 34V is connected to the V-phase input terminal of the first converter 41 via a switch 1c and the top end portion side of the U-phase first winding 34U is connected to the V-phase input terminal of the first converter 41 via a switch 1d.

Moreover, the bottom end portion side of the W-phase first winding 34W is connected to the W-phase input terminal of the first converter 41 via a switch 1e and the top end portion side of the V-phase first winding 34V is connected to the W-phase input terminal of the first converter 41 via a switch if.

The bottom end portion side of the U-phase second winding 35U is connected to the U-phase input terminal of the second converter 42 via a switch 2a and the top end portion side of the W-phase second winding 35W is connected to the U-phase input terminal of the second converter 42 via a switch 2b.

Moreover, the bottom end portion side of the V-phase second winding 35V is connected to the V-phase input terminal of the second converter 42 via a switch 2c and the top end portion side of the U-phase second winding 35U is connected to the V-phase input terminal of the second converter 42 via a switch 2d.

Moreover, the bottom end portion side of the W-phase second winding 35W is connected to the W-phase input terminal of the second converter 42 via a switch 2e and the top end portion side of the V-phase second winding 35V is connected to the W-phase input terminal of the second converter 42 via a switch 2f.

In the example shown in FIG. 3, the switch (switch mechanism) 1 or 2 is capable of switching between the connected state and the disconnected state for each portion of the first winding 34 and the second winding 35, each portion corresponding to each phase.

[C. Cut Off Either First Winding 34 or Second Winding 35 in Phase where Short-Circuit has Occurred]

Here, it is assumed that a short-circuit occurs between the U-phase first winding 34U and the U-phase second winding 35U in the U-phase coil 33U.

In this case, the switch 1a and the switch 1d of the six first switches 1, which connect to the U-phase first winding 34U, are switched from the connected state to the disconnected state. Alternatively, the switch 2a and the switch 2d of the six second switches 2, which connect to the U-phase second winding 35U, are switched from the connected state to the disconnected state. The other ten switches remain in the connected state.

In this case, one of the U-phase first winding 34U and the U-phase second winding 35U is cut off from the external apparatus.

[D. Cut Off Both First Winding 34 and Second Winding 35 in Phase where Short-Circuit has Occurred]

It is assumed that a short-circuit occurs between the U-phase first winding 34U and the U-phase second winding 35U in the U-phase coil 33U.

In this case, the switch 1a and the switch 1d of the six first switches 1, which connect to the U-phase first winding 34U, are switched from the connected state to the disconnected state. In addition, the switch 2a and the switch 2d of the six second switches 2, which connect to the U-phase second winding 35U, are switched from the connected state to the disconnected state. The other eight switches remain in the connected state.

In this case, both the U-phase first winding 34U and the U-phase second winding 35U are cut off from the external apparatus.

### [Cause Converter 41, 42 to Perform Switching]

Here, the first converter 41 and the second converter 42 can also serve as the first switches 39 and the second switches 40 (in this case, the converters are considered as switch mechanisms). It should be noted that in this case, the switches 39 and 40 (or the switches 1 and 2) can be omitted.

That is, the control of the first converter 41 and the second converter 42 enables switching between the connected state and the disconnected state between the coil 33 (first winding 34 and second winding 35) and the external apparatus (first apparatus 43 or second apparatus 44).

For example, making a description with an example of Section A above, driving of one of the first converter 41 and the second converter 42 is stopped in a case where a sign of a short-circuit or a short-circuit has occurred in a portion of the coils 33. Accordingly, either the first windings 34 or the second windings 35 are cut off from the external apparatuses (first apparatus 43 and second apparatus 44).

Moreover, for example, making a description with an example of Section B above, driving of both the first converter 41 and the second converter 42 is stopped in a case where a sign of a short-circuit or a short-circuit has occurred in a portion of the coils 33. Accordingly, both the first windings 34 and the second windings 35 are cut off from the external apparatuses (first apparatus 43 and second apparatus 44).

### [Safety]

Here, the patterns of Sections A, C, and D above is based on the perspective that the electric generator 14 is partially caused to operate in order to obtain electric power from the electric generator 14 even if a short-circuit has occurred in the coil 33. On the other hand, the pattern of Section B above is based on the perspective that the electric generator 14 is cut off from the external apparatus in order to further enhance the safety if a short-circuit in the coil 33 has occurred.

In the patterns of Sections A, C, and D above, the electric generator 14 is caused to operate in a state in which a partial fault has occurred in the coil 33. Thus, from perspective of the safety, the patterns of Sections A, C, and D are lower in safety than the pattern of Section B. However, in the present embodiment, electric power can be obtained from the electric generator 14 while required safety criteria are sufficiently satisfied also in the patterns of Sections A, C, and D because the configuration of the two or more windings as described above suppresses the flow of short-circuit current.

### [Case of Motor]

A case where the present technology is used as an aircraft motor will now be described. In a case of the motor, for example, a thruster that produces aircraft thrust is coupled to the shaft of the rotor 20, the power supply 46 (e.g., see FIG. 7 to be described later) is provided on the side of the first apparatus 43 and the second apparatus 44. Moreover, inverters are used in place of the converters 42 and 42.

In a case of the aircraft motor, as in the patterns of Sections A, C, and D above, the switch 39 or 40 (or the switch 1 or 2) cuts off a portion of the first winding 34 and the second winding 35 from the power supply 46 so that it becomes the disconnected state and keeps the other portion of the first winding 34 and the second winding 35 in the connected state with the power supply 46 if a short-circuit has occurred. Accordingly, driving of the motor and the thruster can be maintained in order to prevent crash of the aircraft even if a short-circuit has occurred.

### <Another Example in Coil 33>

Next, another example in the coil 33 will be described. FIG. 5 is a diagram showing the other example in the coil 33.

As shown in FIG. 5, the coil 33 has a double-layer structure in this example. Specifically, the first winding 34 and the second winding 35 are wound around the tooth 32, laminated in two layers in a radial direction of the tooth 32 (direction orthogonal to the axial direction of the tooth 32). Moreover, the first winding 34 and the second winding 35 are wound around the tooth 32 in such a manner that one winding is adjacent to the other winding in the radial direction of the tooth 32.

Moreover, also in the example shown in FIG. 5, as in the example shown in FIG. 4, the first winding 34 and the second winding 35 are alternately wound in a helical form around the tooth 32 in such a manner that one winding is adjacent to the other winding in the axial direction of the tooth 32 (magnetic core). Moreover, the first winding 34 and the second winding 35 are electrically separated from each other so that they are electrically independent windings (i.e., they are not electrically and physically connected).

In the example shown in FIG. 5, the number of windings per unit length in the coil 33 can be increased as compared to the example shown in FIG. 4. Therefore, electric power generated by the electric generator 14 can be increased. In addition, in the example shown in FIG. 5, portions of the same winding are not adjacent to each other not only in the axial direction of the tooth 32, but also in the radial direction of the tooth 32 (direction orthogonal to the axial direction). Therefore, the situation where portions of the same winding are short-circuited and short-circuit current flows there can be suitably prevented.

It should be noted that although the number of layers in the coil 33 is two in the example shown in FIG. 5, the number of layers in the coil 33 may be three or more.

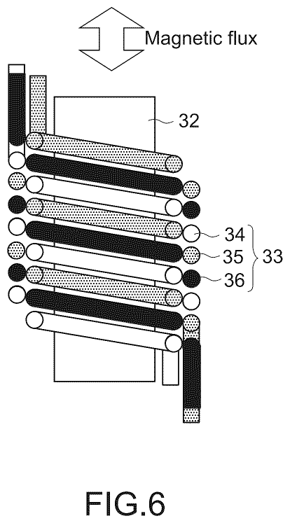

FIG. 6 is a diagram showing a still another example in the coil 33. In the example shown in FIG. 6, the coil 33 is constituted by three windings including the first winding 34, the second winding 35, and a third winding 36.

In the example shown in FIG. 6, the first winding 34, the second winding 35, and the third winding 36 are alternately wound in a helical form around the tooth 32 in such a manner that one winding is adjacent to the other winding in the axial direction of the tooth 32 (magnetic core). Moreover, the first winding 34, the second winding 35, and the third winding 36 are electrically separated from one another so that they are electrically independent windings (i.e., they are not electrically and physically connected).

Moreover, the first winding 34, the second winding 35, and the third winding 36 are wound around the tooth 32, laminated in two layers in a radial direction of the tooth 32 (direction orthogonal to the axial direction of the tooth 32) in such a manner that one winding is adjacent to the other winding.

As the number of windings is increased as in the example shown in FIG. 6, the distance between portions of the same winding increases. For example, two windings, the second winding 35 and the third winding 36, are interposed between portions of the first winding 34 in the axial direction of the tooth 32. Therefore, the distance between the portions of the first winding 34 further increases. Accordingly, the situation where portions of the same winding are short-circuited and short-circuit current flows there can be more suitably prevented.

It should be noted that although the number of windings is three in the example shown in FIG. 6, the number of windings may be four or more. Moreover, although the number of layers in the coil 33 is two in the example shown in FIG. 6, the number of layers in the coil 33 may be only one or may be three or more.

It should be noted that in a case where the third winding is added, a third converter that converts three-phase alternating current from the third winding into direct current, a third switch interposed between the third winding and the third converter, and the like are further added.

### <Actions, etc.>

Next, actions, etc. in the electric generator 14 according to the present embodiment will be described.

First of all, a case where a typical electric generator 14 used on the ground will be described for comparison. In general, the typical electric generator 14 employs a method of cutting off the supply of electricity to the electric generator 14 so as to stop its driving in a case where a fault has occurred in a component such as the coil 33 in order to prevent the fault from spreading.

On the other hand, as to the electric generator 14 for aircraft that generates electricity with rotational energy from the engine shaft 15 of the aircraft as in the present embodiment, a method of simply cutting off the supply of electricity to the electric generator 14 so as to stop its driving cannot be employed unlike the typical electric generator 14 used on the ground. It is because the aircraft will crash if the engine shaft 15 is stopped.

For example, a case of a typical coil 33 constituted by a single winding or a case of the coil 33 constituted by two electrically connected windings (see Patent Literature 1 above) will be assumed. In this case, since portions of the substantially same winding are short-circuited, a loop path due to the short-circuit is formed and short-circuit current flows there. Then, counter electromotive force due to the rotation of the engine shaft 15 keeps generating high heat due to short-circuit current in the coil 33 of the electric generator 14. It may lead to fire in the engine.

In order to avoid such a situation, a possible approach is to provide a cut-off mechanism for cutting off the engine shaft 15 from the shaft of the rotor 20 in the electric generator 14. The cut-off mechanism is, for example, a clutch mechanism for mechanically cutting off the engine shaft 15 from the shaft of the rotor 20 in the electric generator 14. Moreover, the cut-off mechanism may be a shear pin that cuts off the engine shaft 15 from the shaft of the rotor 20 in the electric generator 14 by breaking once a torque larger than a threshold is applied between the engine shaft 15 and the shaft of the rotor 20.

However, the use of the clutch mechanism greatly increases the weight and it also increases the costs. Moreover, in a case where the shear pin is used, the shear pin does not effectively work when a torque between the engine shaft 15 and the shaft of the rotor 20, which is caused by a short-circuit in the coil 33, is smaller than the threshold. That is, the shear pin has poor reliability.

Moreover, a motor that drives a thruster that produces aircraft thrust also has problems similar to those of the electric generator 14 for aircraft. That is, as to the aircraft motor, the method of simply cutting off the supply of electricity to the motor so as to stop its driving if a short-circuit has occurred cannot be employed unlike the typical motor used on the ground. It is because the aircraft will crash if the motor is stopped. Alternatively, there is a case where winds or the like hitting against a fan or propeller connected to the motor during the flight phase rotates it even though the supply of electricity to the motor is cut off, and it cannot be stopped during the flight phase.

If a typical coil 33 or the like with a single winding is kept supplied with electric power for maintaining the aircraft's flight or the motor is kept rotated by external force in a case where a short-circuit has occurred in the coil 33, high heat due to short-circuit current is kept generated in the coil 33. It may lead to motor fire.

In view of this, in the present embodiment, the two or more windings are each helically wound around the tooth 32 in such a manner that one winding is adjacent to the other winding in the axial direction of the tooth 32 (magnetic core) and are independent windings electrically separated from each other.

Accordingly, in the present embodiment, a short-circuit between portions of the same winding is prevented. Moreover, even if a short-circuit has occurred between different windings, a loop path due to the short-circuit is not easily formed and short-circuit current does not easily flow there. Therefore, for example, also in a situation where the engine shaft 15 needs to be continuously driven for keeping the rotor 20 rotated (or in a situation where the aircraft motor needs to be continuously rotated), damage due to a short-circuit can be minimized. That is, in the present embodiment, fire or the like due to a short-circuit in the coil 33 can be suitably prevented while maintaining the safe flight of the aircraft.

In addition, in the present embodiment, the weight and costs can be reduced as compared to a case where the clutch mechanism is provided. Moreover, the reliability can be enhanced as compared to a case where the shear pin is provided.

Moreover, in the present embodiment, in the example shown in FIGS. 5 and 6, the two or more windings are laminated in multiple layers in the radial direction of the tooth 32 (magnetic core) and the two or more windings are each wound around the tooth 32 in such a manner that one winding is adjacent to the other winding in this radial direction.

By laminating the two or more windings in multiple layers in the radial direction of the tooth 32 (magnetic core) in this manner, the number of windings per unit length in the coil 33 can be increased, and electric power generated by the electric generator 14 (driving force of the motor) can be increased.

In addition, by arranging the two or more windings in such a manner that one winding is adjacent to the other winding in the radial direction of the tooth 32, portions of the same winding can be prevented from being adjacent to each other not only in the axial direction of the tooth 32, but also in the radial direction of the tooth 32 (direction orthogonal to the axial direction). Accordingly, the situation where portions of the same winding are short-circuited and short-circuit current flows there can be more suitably prevented.

Moreover, in the present embodiment, the switches (switch mechanisms) each capable of switching between the connected state and the disconnected state between the coil 33 and the external circuit (first apparatus 43 or second apparatus 44: in a case of the motor, the power supply) respectively corresponding to the windings are provided.

Accordingly, damage due to a short-circuit between the windings can be further reduced by each switch cutting off the connection between the winding and the external apparatus depending on needs in a case where a sign of a short-circuit or a short-circuit has occurred between the windings.

In addition, as to switching of the switches, in the aspect in which some portions between the windings and the external apparatuses are put in the connected state and the other portions are put in the disconnected state as in the patterns of Sections A, C, and D above, electric power can be obtained from the electric generator 14 (in a case of the motor, the aircraft's flight can be maintained) in a state in which required safety criteria are sufficiently satisfied. On the other hand, in the aspect in which all portions between the windings and the external apparatuses are put in the disconnected state as in the pattern of Section B above, the safety can be further enhanced.

### Second Embodiment

Next, a second embodiment of the present technology will be described. In descriptions of the second embodiment and the following part, members having configurations and functions similar to those of the above-mentioned first embodiment will be denoted by the same reference signs, descriptions thereof will be omitted or simplified, and points different from those of the first embodiment will be described.

Here, a case where the first winding 34 and the second winding 35 are short-circuited at two or more positions in the U-phase coil 33U will be assumed with reference to FIG. 2. In this case, short-circuit current is generated because a loop path is formed as in a typical short-circuit between portions of the same winding. It is difficult to cope with it by cutting off the coil 33 from the external apparatus by switching of the switch 39 or 40 (or the switch 1 or 2), stopping driving of the converter 41, 42, or the like. Therefore, the short-circuit current cannot be prevented.

That is, in the above-mentioned first embodiment, it is possible to cope with a short-circuit at a single position in the coil 33, but it may be difficult to cope with short-circuits at two or more positions in the coil 33.

In view of this, in the second embodiment, provided is a technology of minimizing damage due to short-circuit current even if short-circuits have occurred at two or more positions in the coil 33.

FIG. 7 is a diagram showing an electric generator 14 according to the second embodiment. In the second embodiment, the switches 39 and 40 (or the switches 1 and 2) are not provided unlike the first embodiment (it should be noted that also in the first embodiment, the switches 39, 40, 1, and 2 can be omitted: in a case where the converters function as the switch mechanisms).

Moreover, in the second embodiment, a power supply 46 that supplies electric power to the first apparatus 43 and the second apparatus 44 is further connected to the DC bus 45 unlike the first embodiment. The power supply 46 may be another electric generator 14 that generates electricity with power from another engine shaft 15 or may be a battery for emergency or the like.

The first converter 41 converts three-phase alternating current generated in the first winding 34 into direct current and provides the direct current to the external apparatus (first apparatus 43 or second apparatus 44). The second converter 42 converts three-phase alternating current generated in the second winding 35 into direct current and provides the direct current to the external apparatus.

Moreover, in a case where short-circuits have occurred at two positions in the first winding 34 and the second winding 35 and short-circuit current has flowed there, the first converter 41 converts direct current from the power supply 46 into three-phase alternating current and provides the three-phase alternating current to the first windings 34 in the three phases.

Similarly, in a case where short-circuits have occurred at two positions in the first winding 34 and the second winding 35 and short-circuit current has flowed there, the second converter 42 converts direct current from the power supply 46 into three-phase alternating current and provides the three-phase alternating current to the second windings in the three phases 35.

That is, the first converter 41 and the second converter 42 normally function as converters that convert alternating current into direct current, and the first converter 41 and the second converter 42 function as inverters that convert direct current into alternating current in an abnormal case where short-circuit current has been generated.

Typically, the first converter 41 and the second converter 42 supply current to cancel a magnetic flux change in the teeth 32 to the first winding 34 and the second winding 35 in at least the phase where the short-circuit has occurred in an abnormal case where short-circuit current has been generated.

It should be noted that either the first converter 41 or the second converter 42 may be used to supply current to cancel the magnetic flux change to either the first winding 34 or the second winding 35 and the other converter may be stopped.

It will be described specifically using an example. It is assumed that in the U-phase coil 33U, short-circuits have occurred at two or more positions between the U-phase first winding 34U and the U-phase second winding 35U and short-circuit current has been flowed in the U-phase coil 33U.

In this case, the first converter 41 and the second converter 42 convert direct current from the power supply 46 via the DC bus 45 into three-phase alternating current. Then, the first converter 41 and the second converter 42 provide current to cancel a magnetic flux change in the U-phase tooth 32U to the U-phase first winding 34U and the U-phase second winding 35U as alternating current for the U-phase.

On the other hand, the first converter 41 and the second converter 42 provide current to cancel a magnetic flux change in the V-phase tooth 32V to the V-phase first winding 34V and the V-phase second winding 35V as alternating current for the V-phase. Similarly, the first converter 41 and the second converter 42 provide current to cancel a magnetic flux change in the W-phase tooth 32W to the W-phase first winding 34W and the W-phase second winding 35W as alternating current for the W-phase.

Alternatively, either the first converter 41 or the second converter 42 provides current to cancel a magnetic flux change in the U-phase tooth 32U as alternating current for the U-phase to either the U-phase first winding 34U or the U-phase second winding 35U and the other converter is stopped.

In this case, either the first converter 41 or the second converter 42 provides current to cancel a magnetic flux change in the V-phase tooth 32V to either the V-phase first winding 34V or the V-phase second winding 35V as alternating current for the V-phase. Similarly, either the first converter 41 or the second converter 42 provides current to cancel a magnetic flux change in the W-phase tooth 32W to either the W-phase first winding 34W or the W-phase second winding 35W as alternating current for the W-phase.

It should be noted that the case where after short-circuit current is generated in a single phase, the magnetic flux change in the teeth 32 is cancelled also in the other phases where no short-circuit has occurred has been described herein. However, after short-circuit current is generated in a single phase, the electricity generation may be maintained by taking electric power from the other phases where no short-circuit has occurred. For example, in a case where short-circuit current has been flowed in a U-phase, electric power may be taken from the V-phase or the W-phase.

At this time, electric power generated in the V-phase or the W-phase may be used by the first apparatus 43, the second apparatus 44, or the like or may be used electric power for cancelling a magnetic flux change in the U-phase tooth 32U in the U-phase. In this case, the power supply 46 may be omitted.

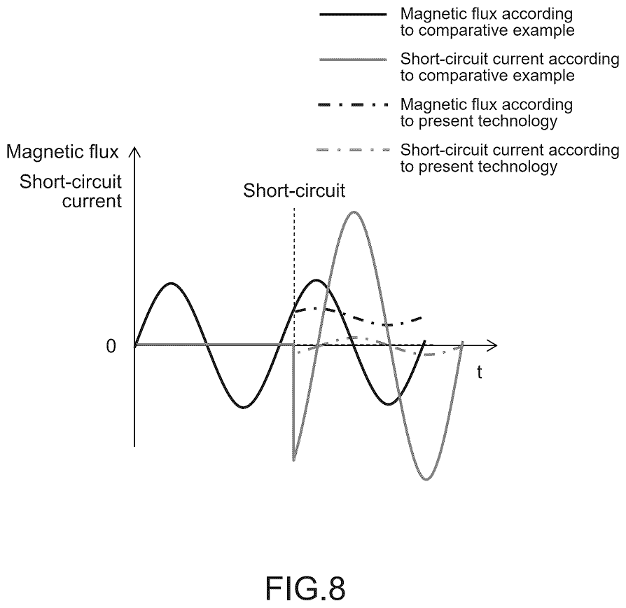

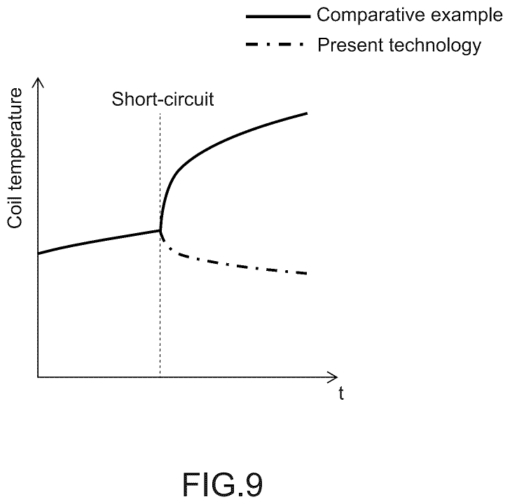

FIG. 8 is a diagram for comparing magnetic flux and short-circuit current in the electric generator 14 according to the comparative example and the electric generator 14 according to the second embodiment of the present technology. FIG. 9 is a diagram for comparing temperature of the coils 33 in the electric generator 14 according to the comparative example and the electric generator 14 according to the second embodiment of the present technology.

In the comparative example shown in FIGS. 8 and 9, the coil 33 is constituted by a single winding. In the comparative example, as shown in FIG. 8, after a short-circuit in the winding in a particular phase occurs, a magnetic flux change in the teeth 32 due to the rotation of the rotor 20 remains the same as before the short-circuit, and large short-circuit current flows through the coil 33 in accordance with the magnetic flux change.

Moreover, in the comparative example, as shown in FIG. 9, the temperature of the coil 33 may increase because of the short-circuit current, resulting in damage such as fire.

On the other hand, in the second embodiment of the present technology, as shown in FIG. 8, after a short-circuit in the winding in a particular phase occurs, a magnetic flux change in the teeth 32 due to the rotation of the rotor 20 is cancelled. Therefore, the flow of the short-circuit current is suppressed.

Moreover, in the second embodiment of the present technology, as shown in FIG. 9, a temperature rise due to the short-circuit current is suppressed. Accordingly, damage such as fire can be prevented.

It should be noted that the electric generator 14 according to the second embodiment is advantageous, in particular, in that it can cope with short-circuits that have occurred at two or more positions between the first winding 34 and the second winding 35.

### Third Embodiment

Next, a third embodiment of the present technology will be described. In the third embodiment, detection of a sign of a short-circuit or a short-circuit in two or more windings will be described. It should be noted that detection of a sign of a short-circuit or a short-circuit according to the third embodiment can be applied to the above-mentioned first and second embodiments.

### <Short-Circuit Detection: First Example>

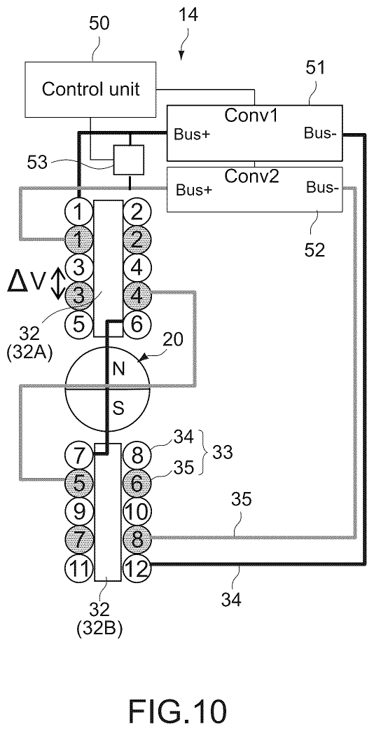

FIG. 10 is a diagram showing a first example regarding detection of a sign of a short-circuit or a short-circuit in two or more windings.

In the example shown in FIG. 10, a stator 30 of an electric generator 14 includes two teeth 32 corresponding to the same phase (e.g., U-phase). It should be noted that in the description of the third embodiment, out of the two teeth 32 corresponding to the same phase, one tooth 32 will be referred to as a first tooth 32A and the other tooth 32 will be referred to as a second tooth 32B.

The first winding 34 is constituted by a single winding corresponding to the same phase (e.g., U-phase). The second winding 35 is constituted by a single winding corresponding to the same phase (e.g., U-phase).

As in each of the above-mentioned embodiments, the first winding 34 and the second winding 35 are each helically wound around the tooth 32 in an axial direction of the tooth 32 in such a manner that one winding is adjacent to the other winding. Moreover, the first winding 34 and the second winding 35 are independent windings each electrically separated from the other windings. The number of laminations of the coil 33 may be two or more (see FIG. 5) and the number of windings may be three or more (see FIG. 6).

Here, since three phases, U-, V-, and W-phases, have basically similar configurations, one of the three phases will be described as a representative in the description of FIG. 10. It should be noted that the electric generator 14 may be a single-phase electric generator 14 or the like.

A first converter 51 converts alternating current generated in the first winding 34 into direct current and provides the direct current to the external apparatus (first apparatus 43 or second apparatus 44). Moreover, a second converter 52 converts alternating current generated in the second winding 35 into direct current and provides the direct current to the external apparatus (first apparatus 43 or second apparatus 44). The first converter 51 and the second converter 52 each include Bus+ and Bus−.

One end of the first winding 34 is connected to Bus+ of the first converter 51 and the other end of the first winding 34 is connected to Bus− of the first converter 51. Moreover, one end of the second winding 35 is connected to Bus+ of the second converter 52 and the other end of the second winding 35 is connected to Bus− of the second converter 52.

Here, a portion of the first winding 34 and the second winding 35, which is connected to Bus+ and becomes a start wire for the tooth 32, will be referred to as a wiring start. On the other hand, a portion of the first winding 34 and the second winding 35, which is connected to Bus− and becomes an end wire for the tooth 32, will be referred to as a wiring end.

In FIG. 10, the numbers are added to the first winding 34 and the second winding 35 in the order from the wiring start to the wiring end.

As it can be seen from FIG. 10, the first winding 34 and the second winding 35 are different from each other in the number of windings wound around the tooth 32. In the example shown in FIG. 10, the first winding 34 is larger in the number of windings than the second winding 35 at each of the first tooth 32A and the second tooth 32B.

Therefore, the first winding 34 and the second winding 35 are different in electromotive force. Accordingly, there is a potential difference ΔV between the first winding 34 and the second winding 35.

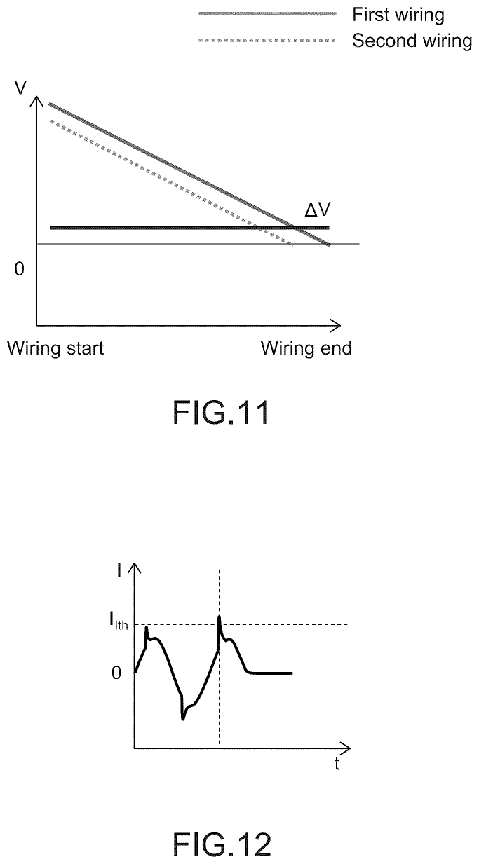

FIG. 11 is a diagram showing the potential difference ΔV between the first winding 34 and the second winding 35. Since the first winding 34 is larger in the number of windings than the second winding 35, the first winding 34 has a higher potential than the second winding 35 as shown in FIG. 11. Therefore, there is a potential difference ΔV with a constant magnitude from the wiring start to the wiring end between the first winding 34 and the second winding 35.

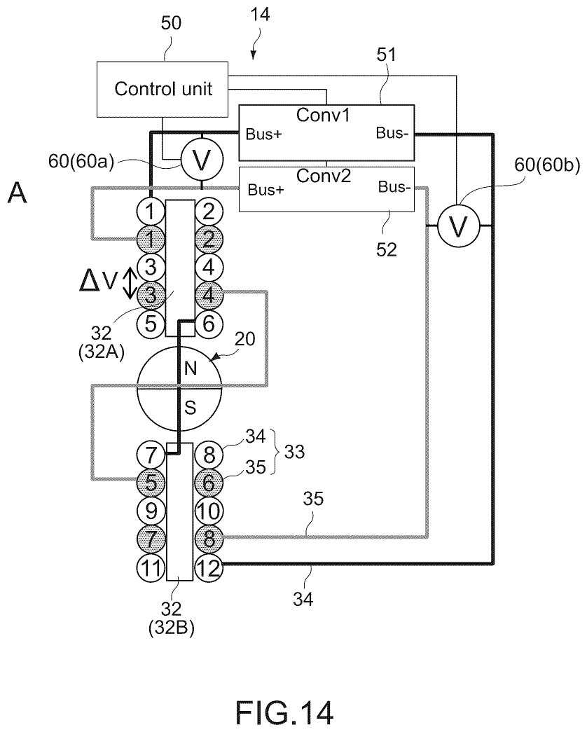

An ammeter 53 (detector) that detects partial discharge current based on the potential difference ΔV is provided between the first winding 34 and the second winding 35. It should be noted that a voltmeter 60 that detects the potential difference ΔV (detector: for example, see FIG. 14 and the like to be described later) may be provided in place of or in addition to the ammeter 53.

A control unit 50 (detector) acquires a partial discharge current detected by the ammeter 53 from the ammeter 53. Based on the partial discharge current, the control unit 50 (detector) detects a sign of a short-circuit or a short-circuit between the first winding 34 and the second winding 35.

FIG. 12 is a diagram showing an example of the partial discharge current. As shown in FIG. 12, the partial discharge current fluctuates over time because of the rotation of the rotor 20.

The control unit 50 determines whether the partial discharge current is smaller than a predetermined threshold Ith. Then, in a case where the partial discharge current is smaller than the threshold Ith, the control unit 50 determines that it is normal. On the other hand, in a case where the partial discharge current is equal to or larger than the threshold Ith, the control unit 50 determines that it is a sign of a short-circuit.

On the other hand, in a case where the first winding 34 and the second winding 35 are short-circuited, the potential difference ΔV between the first winding 34 and the second winding 35 becomes zero and the partial discharge current becomes zero. Therefore, the control unit 50 determines that a short-circuit has occurred when a predetermined time has elapsed after the partial discharge current becomes zero (for distinguishing it from zero of partial discharge current as a sine wave).

That is, since in the first example, the potential difference ΔV is found between the first winding 34 and the second winding 35, a sign of a short-circuit or a short-circuit can be easily detected.

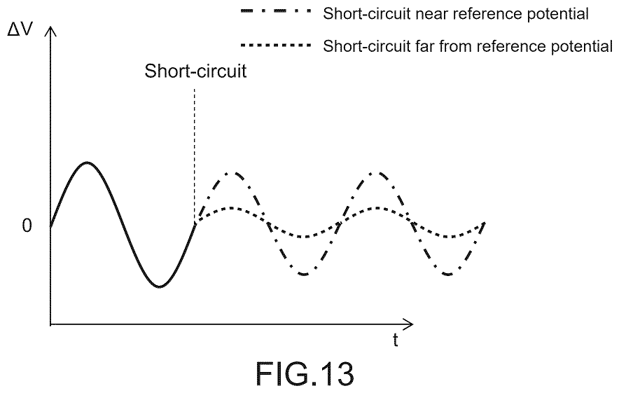

Here, in a case of using the voltmeter 60 (e.g., see FIG. 14 and the like to be described later), whether a short-circuit has occurred may be determined by the voltmeter 60 detecting a change rate of the potential difference ΔV before/after the short-circuit. FIG. 13 is a diagram showing a change in potential difference ΔV before/after the short-circuit.

It should be noted that as shown in FIG. 13, a change rate of the potential difference ΔV before/after the short-circuit changes depending on a short-circuit position. Therefore, the short-circuit position can also be determined based on the change rate of the potential difference ΔV before/after the short-circuit.

On the other hand, in a case where the short-circuit position is a position relatively far from the voltmeter 60 or in a case where the short-circuit position is near a reference potential for the first winding 34 and the second winding 35 (e.g., in a case where that phase is connected to Bus-inside the first converter 51 or the second converter 52, the short-circuit position is close it), the change rate of the potential difference ΔV before/after the short-circuit is low, so it is difficult to detect it.

In order to cope with it, a plurality of voltmeters 60 may be placed at different positions in the coil 33 (e.g., between phase input terminals or between null points of first converter 51 and the second converter 52), and the occurrence of a short-circuit and the occurrence position may be determined based on each of potential differences ΔV measured by these voltmeters 60. Alternatively, the occurrence of a short-circuit and the occurrence position may be determined by measuring the potential difference ΔV at a point of time when it is not connected to Bus− described above.

FIG. 14 is a diagram showing an example in a case where a plurality of voltmeters 60 is provided in single-phase coils 33 (e.g., U-phase). In the example shown in FIG. 14, two voltmeters 60 including a first voltmeter 60a and a second voltmeter 60b are provided.

The first voltmeter 60a is interposed between the first winding 34 and the second winding 35 in the vicinity of Bus+ of the first converter 51 and the second converter 52 (between Bus+ and the wiring start). On the other hand, the second voltmeter 60b is interposed between the first winding 34 and the second winding in the vicinity of Bus− of the first converter 51 and the second converter 52 (between Bus− and the wiring end).

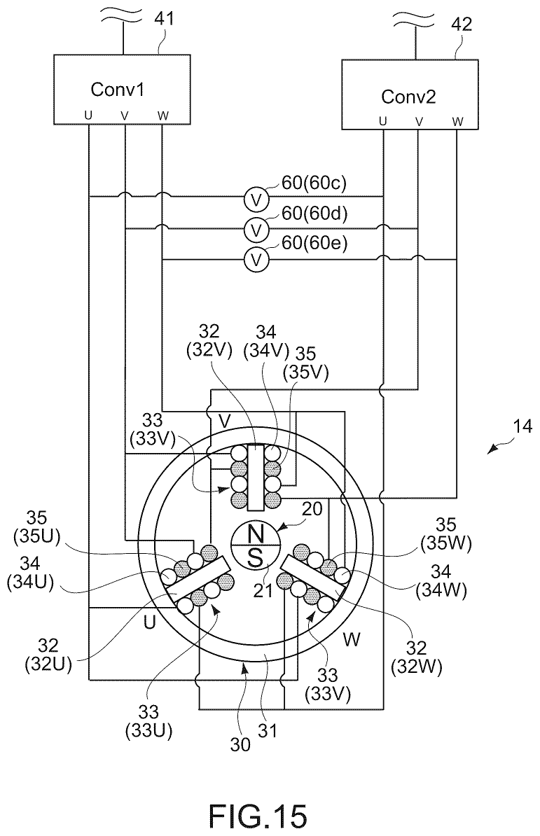

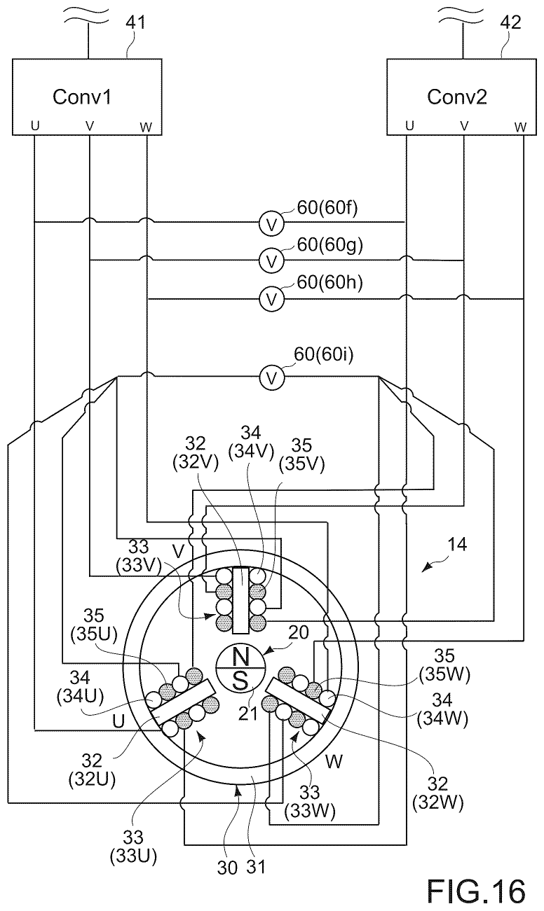

FIGS. 15 and 16 are diagrams showing an example in a case where the plurality of voltmeters 60 is provided in three-phase coils 33. FIG. 15 shows an example of the plurality of voltmeters 60 in a case where the coils 33 are connected by delta connection. FIG. 16 shows an example of the plurality of voltmeters 60 in a case where the coils are connected by Y-connection. It should be noted that in FIGS. 15 and 16, the first winding 34 and the second winding 35 have a potential difference ΔV because they are different from each other in the number of windings, for example.

Referring to FIG. 15, three voltmeters 60 including a first voltmeter 60c, a second voltmeter 60d, and a third voltmeter 60e are provided in this example by the delta connection.

The first voltmeter 60c is interposed between a conducting wire connected to the U-phase input terminal of the first converter 41 (conducting wires pulled out of the U-phase first winding 34U and the W-phase first winding 34W and connected) and a conducting wire connected to the U-phase input terminal of the second converter 42 (conducting wires pulled out of the U-phase second winding 35U and the W-phase second winding 35W and connected).

Moreover, the second voltmeter 60d is interposed between a conducting wire connected to the V-phase input terminal of the first converter 41 (conducting wires pulled out of the V-phase first winding 34V and the U-phase first winding 34U and connected) and a conducting wire connected to the V-phase input terminal of the second converter 42 (conducting wires pulled out of the V-phase second winding 35V and the U-phase second winding 35U and connected).

Moreover, the third voltmeter 60e is interposed between a conducting wire connected to the W-phase input terminal of the first converter 41 (conducting wires pulled out of the W-phase first winding 34W and the V-phase first winding 34V and connected) and a conducting wire connected to the W-phase input terminal of the second converter 42 (conducting wires pulled out of the W-phase second winding 35W and the V-phase second winding 35V and connected).

Referring to FIG. 16, three voltmeters 60 including a first voltmeter 60f, a second voltmeter 60g, a third voltmeter 60h, and a fourth voltmeter 60i are provided in this example by the Y-connection.

The first voltmeter 60f is interposed between a conducting wire connected to the U-phase input terminal of the first converter 41 (a conducting wire pulled out of the U-phase first winding 34U) and a conducting wire connected to the U-phase input terminal of the second converter 42 (a conducting wire pulled out of the U-phase second winding 35U).

Moreover, the second voltmeter 60g is interposed between a conducting wire connected to the V-phase input terminal of the first converter 41 (a conducting wire pulled out of the V-phase first winding 34V) and a conducting wire connected to the V-phase input terminal of the second converter 42 (a conducting wire pulled out of the V-phase second winding 35V).

Moreover, the third voltmeter 60g is interposed between a conducting wire connected to the W-phase input terminal of the first converter 41 (a conducting wire pulled out of the W-phase first winding 34W) and a conducting wire connected to the W-phase input terminal of the second converter 42 (a conducting wire pulled out of the W-phase second winding 35W).

Moreover, the fourth voltmeter 60i is interposed between a null point by the Y-connection of the first winding 34 and a null point by the Y-connection of the second winding 35.

In the example shown in FIGS. 14, 15, and 16, the occurrence of a short-circuit and the occurrence position are determined based on each of potential differences ΔV measured by the voltmeters 60. Accordingly, the occurrence of a short-circuit and the occurrence position can be correctly determined irrespective of a short-circuit position.

In a case where a sign of a short-circuit or a short-circuit has been detected, for example, the control unit 50 stops driving of either the first converter 51 or the second converter and cuts off either the first winding 34 or the second winding 35 from the external apparatus. Alternatively, the control unit 50 stops driving of both the first converter 51 and the second converter and cuts off both the first winding 34 and the second winding 35 from the external apparatus.

Alternatively, in the aspect in which the switches 39 and 40 (or the switches 1 and 2) are provided as in the first embodiment, the control unit 50 may (partially or generally) cut off the first winding 34 and the second winding 35 (coil 33) from the external apparatus by switching the switches 39 and 40 or 1 and 2 in a case where a sign of a short-circuit or a short-circuit has been detected.

Alternatively, as in the second embodiment, the control unit 50 may cancel a magnetic flux change caused in the teeth 32 by the rotation of the rotor 20 by driving the first converter 51 and the second converter as inverters in a case where a sign of a short-circuit or a short-circuit has been detected. Moreover, in a case where a sign of a short-circuit or a short-circuit has been detected, the control unit 50 may notify a host system or pilot of the sign of the short-circuit or the short-circuit.

Here, the first winding 34 and the second winding 35 are covered with a filler made of insulating material such as resin in some cases. In those cases, a case where partial discharge current based on the potential difference ΔV between the first winding 34 and the second winding 35 is not easily monitored under an environment of high-voltage and low-atmospheric pressure is assumed.

Therefore, the control unit 50 may control the first converter 51 and the second converter 52 to apply exploration voltage (e.g., square wave) between the first winding 34 and the second winding 35 from the converters 51 and 52. The exploration voltage is applied for a short period (about several milliseconds) at a predetermined cycle (about several seconds).

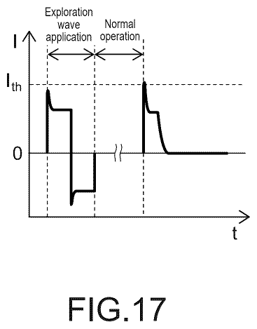

FIG. 17 is a diagram showing partial discharge current when the exploration voltage is applied. The control unit 50 repeats processing of applying the exploration voltage between the first winding 34 and the second winding 35 for a short period at a predetermined cycle.

Moreover, the control unit 50 determines whether the partial discharge current is smaller than the predetermined threshold Ith. Then, the control unit 50 determines that it is normal in a case where the partial discharge current is smaller than the threshold Ith. On the other hand, in a case where the partial discharge current is equal to or larger than the threshold Ith, the control unit 50 determines that it is a sign of a short-circuit. Moreover, in a case where the partial discharge current still takes a zero value after applying the exploration voltage, the control unit 50 determines that a short-circuit has occurred.

It should be noted that although the partial discharge current is monitored in the first example, capacitance between the first winding 34 and the second winding 35 may be monitored. Moreover, insulation resistance between the first winding 34 and the second winding 35 may be monitored. Alternatively, a combination of two or more of the partial discharge current, the capacitance, and the insulation resistance (electrical element based on the potential difference ΔV) may be monitored.

Hereinabove, the case where a sign of a short-circuit or a short-circuit is detected by monitoring partial discharge current, capacitance, insulation resistance, and/or the like between the first winding 34 and the second winding 35 during electricity generation by the electric generator 14 (in a case of the motor, during the driving of the motor) has been described. On the other hand, a sign of a short-circuit or a short-circuit may be detected by monitoring partial discharge current, capacitance, insulation resistance, and/or the like between the first winding 34 and the second winding 35 during non-electricity generation by the electric generator 14 (in a case of the motor, during the stop of the motor).

For example, when the aircraft has stopped at an airdrome, an electric generator 14 for aircraft generates no electricity (the aircraft motor is not driven). On the other hand, exploration voltage as shown in FIG. 17 can be applied also during non-electricity generation (during the stop of the motor) of the electric generator 14. Then, the control unit 50 is capable of detecting a sign of a short-circuit or a short-circuit by monitoring partial discharge current, capacitance, insulation resistance, and/or the like based on a potential difference caused by this exploration voltage.

Moreover, the detected value(s) of the partial discharge current, capacitance, insulation resistance, and/or the like may be recorded in time series (irrespective of electricity generation, non-electricity generation, or the like). In this case, for example, the control unit 50 may determine whether the electric generator 14 (or the motor) has to undergo maintenance based on changes of such value(s) over time and may notify a host system, pilot, maintenance technician, or the like of that. Accordingly, the maintenance intervals for the electric generator 14 (or the motor) can be kept proper, and the maintenance cost can be saved.

### <Short-Circuit Detection: Second Example>

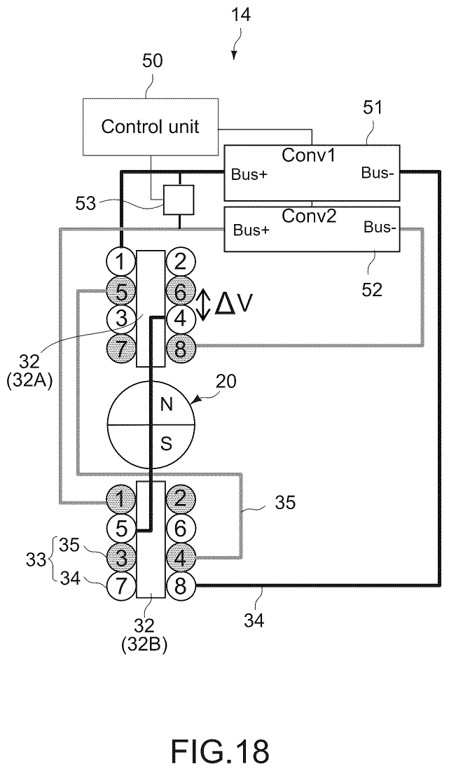

Next, a second example regarding detection of a sign of a short-circuit or a short-circuit in the two or more windings will be described. FIG. 18 is a diagram showing the second example regarding detection of a sign of a short-circuit or a short-circuit in the two or more windings.

It should be noted that in this second example, points different from those of the above-mentioned first example will be mainly described. The second example is different from the first example in terms of the way of winding the first winding 34 and the second winding 35.

In FIG. 18, the numbers are added to the first winding 34 and the second winding 35 in the order from the wiring start to the wiring end.

The first winding 34 is wound around the first tooth 32A toward the top end portion side (rotor 20 side) from the bottom end portion side (back-york portion 31 side) of the first tooth 32A and then wound around the second tooth 32B toward the bottom end portion side (back-york portion 31 side) from the top end portion side (rotor 20 side) of the second tooth 32B.

On the other hand, the second winding 35 is wound around the second tooth 32B toward the bottom end portion side (back-york portion 31 side) from the top end portion (rotor 20 side) of the second tooth 32B and then wound around the first tooth 32A toward the top end portion side (rotor 20 side) from the bottom end portion side (back-york portion 31 side) of the first tooth 32A.

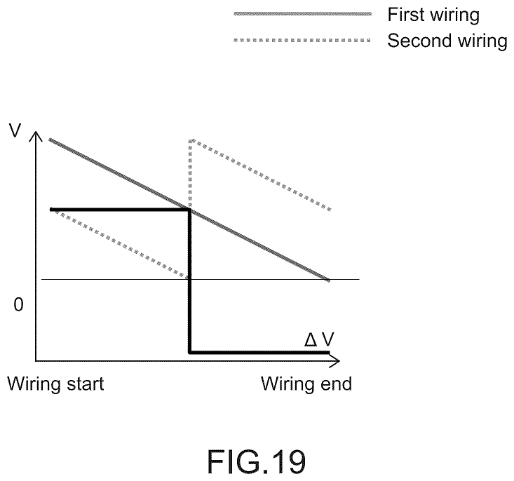

FIG. 19 is a diagram showing the potential difference ΔV between the first winding 34 and the second winding 35. The voltage in the first winding 34 becomes the highest at the wiring start and becomes the lowest, zero, at the wiring end. The voltage in the first winding 34 gradually decreases from the wiring start to the wiring end.

On the other hand, the voltage in the second winding 35 is about half of the first winding 34 at the wiring start, gradually decreases, and becomes zero at the intermediate position between the wiring start and the wiring end. Then, this voltage sharply increases, becomes a value double the first winding 34, and then gradually decreases to the wiring end, and becomes the same value as the wiring start at the wiring end.

Therefore, the value of the potential difference ΔV between the first winding 34 and the second winding 35 is constantly positive between the wiring start and the intermediate position and is constantly negative between the intermediate position and the wiring end.

Since also in this second example, the potential difference ΔV is found between the first winding 34 and the second winding 35 as in the first example, a sign of a short-circuit or a short-circuit can be easily detected. Since in particular, it is easy to increase the potential difference ΔV in the second example, a sign of a short-circuit or a short-circuit can be more easily detected.

The first example and the second example may be combined. For example, as to the way of winding the first winding 34 and the second winding 35 as shown in FIG. 18, the first winding 34 and the second winding 35 may be different in the number of windings.

Reference Signs List

| | |
|---|---|
| 14 | electric |
| 20 | rotor |
| 30 | stator |
| 32 | teeth |
| 33 | coil |
| 34 | first winding |
| 35 | second winding |
| 39, 40 | switch |
| 41, 42, 51, 52 | converter |
| 50 | control unit |
| 53 | ammeter |

1. An electric generator, comprising:
a coil element, including:
a magnetic core that causes a magnetic flux change in an axial direction, and
two or more windings that are each helically wound around the magnetic core in such a manner that each of the two or more windings is adjacent to the other winding in the axial direction of the magnetic core and are independent windings each capable of being electrically separated from the other winding.

2. The electric generator according to claim 1,
wherein the two or more windings are laminated in multiple layers in a radial direction orthogonal to the axial direction of the magnetic cores and are each adjacent to the other winding in the radial direction.

3. The electric generator according to claim 1,
wherein the coil element includes two or more switch mechanisms that are provided to two or more windings and are capable of switching between a connected state and a disconnected state with/from an external circuit.

4. The electric generator according to claim 3,
wherein the coil element includes a plurality of coil elements corresponding to a plurality of phases, and
wherein the switch mechanisms are capable of switching between the connected state and the disconnected state for each portion of the two or more windings, each portion corresponding to each phase.

5. The electric generator according to claim 3,
wherein in a case where a sign of a short-circuit or a short-circuit between windings is detected, the switch mechanism switches the connected state of at least one winding to the disconnected state.

6. The electric generator according to claim 1,
wherein in a case where a sign of a short-circuit or a short-circuit between windings is detected, current to cancel a magnetic flux change caused in the magnetic core is supplied to at least one winding.

7. The electric generator according to claim 1, further comprising a detector that detects a sign of a short-circuit or a short-circuit between windings.

8. The electric generator according to claim 7,
wherein the two or more windings have a potential difference between windings adjacent to each other, and
wherein the detector detects the sign of the short-circuit or the short-circuit by detecting the potential difference or an electrical element caused by the potential difference.

9. The electric generator according to claim 8,
wherein the two or more windings have a potential difference between windings adjacent to each other because of different winding patterns.

10. The electric generator according to claim 9,
wherein the two or more windings are different from each other in the number of windings.

11. The electric generator according to claim 9,
wherein the magnetic core includes a first magnetic core and a second magnetic core,
wherein the first magnetic core includes a first bottom end portion and a first top end portion on both end sides in the axial direction,
wherein the second magnetic core includes a second bottom end portion and a second top end portion on both end sides in the axial direction,
wherein a first winding of the two or more windings is wound around the first magnetic core toward a side of the first top end portion from a side of the first bottom end portion and then wound around the second magnetic core toward a side of the second bottom end portion from a side of the second top end portion, and
wherein a second winding of the two or more windings is wound around the second magnetic core toward the side of the second bottom end portion from the side of the second top end portion and then wound around the first magnetic core toward the side of the second top end portion from the side of the first bottom end portion.

12. The electric generator according to claim 8,
wherein the electrical element comprises at least any one of partial discharge current, capacitance, or insulation resistance between windings adjacent to each other.

13. The electric generator according to claim 8,
wherein voltage to detect the electrical element is applied between windings at a predetermined cycle.

14. The electric generator according to claim 7,
wherein the detector detects a sign of a short-circuit or a short-circuit during electricity generation by the electric generator.

15. The electric generator according to claim 7,
wherein the detector detects a sign of a short-circuit or a short-circuit during non-electricity generation by the electric generator.

16. A coil element, comprising:
a magnetic core that causes a magnetic flux change in an axial direction; and
two or more windings that are each helically wound around the magnetic core in such a manner that each of the two or more windings is adjacent to the other winding in the axial direction of the magnetic core and are independent windings each capable of being electrically separated from the other winding.

17. A motor, comprising:
a coil element, including:
a magnetic core that causes a magnetic flux change in an axial direction, and
two or more windings that are each helically wound around the magnetic core in such a manner that each of the two or more windings is adjacent to the other winding in the axial direction of the magnetic core and are independent windings each capable of being electrically separated from the other winding.

18. An aircraft, comprising:
an electric generator including a coil element including:
a magnetic core that causes a magnetic flux change in an axial direction, and
two or more windings that are each helically wound around the magnetic core in such a manner that each of the two or more windings is adjacent to the other winding in the axial direction of the magnetic core and are independent windings each capable of being electrically separated from the other winding.

19. An aircraft, comprising:
a motor including a coil element including:
a magnetic core that causes a magnetic flux change in an axial direction, and
two or more windings that are each helically wound around the magnetic core in such a manner that each of the two or more windings is adjacent to the other winding in the axial direction of the magnetic core and are independent windings each capable of being electrically separated from the other winding.
